(19) United States
(12) Patent Application Publication
(10) Pub. No.: US 2019/0004903 A1
(43) Pub. Date: Jan. 3, 2019

(54) Data Restoration Method and Apparatus, and Terminal

(71) Applicant: Huawei Technologies Co., Ltd., Shenzhen, Guangdong (CN)

(72) Inventor: Zhigang Li, Shenzhen (CN)

(21) Appl. No.: 15/570,630

(22) PCT Filed: Apr. 29, 2015
(86) PCT No.: PCT/CN2015/077811

§ 371 Date: Oct. 30, 2017

(51) Int. Cl. G06F 11/14; G06F 9/4401

(52) U.S. Cl. CPC G06F 11/1458; G06F 2201/84; G06F 9/441; G06F 11/1417

(57) ABSTRACT

A data restoration method and apparatus, and a terminal, where the data restoration method includes monitoring whether an error occurs in original data stored in a read-only area of a memory when the terminal runs or loads a first operating system, loading a second operating system from the memory when an error occurs in the original data, where the second operating system provides a system restoration function, and obtaining an original data file corresponding to the original data, and restoring the original data to the read-only area of the memory according to the original data file when the terminal runs the second operating system. Hence, a terminal may automatically restore a system when an error occurs in data in a read-only area of a memory.

### CROSS-REFERENCE TO RELATED APPLICATION

This application is a U.S. National Stage of International Patent Application No. PCT/CN2015/077811 filed on Apr. 29, 2015, which is hereby incorporated by reference in its entirety.

### TECHNICAL FIELD

Embodiments of the present disclosure relate to a terminal storage technology, and in particular, to a data restoration method and apparatus, and a terminal.

### BACKGROUND

Currently, an embedded multimedia card (cMMC) is widely used as a main storage medium of a mobile terminal. An intrinsic physical characteristic of a memory in the eMMC may result in generation of a bad block during use, and once the bad block occurs, data originally stored in the block is lost.

An existing eMMC controller generally uses error checking and correction (ECC) to resolve a bad block problem of a memory in a fault-tolerant manner, but an abnormal data problem still cannot be fully resolved. In addition, there is neither a corresponding monitor mechanism nor an extra protection measure for a read-only area of the memory. If an error occurs in data in the read-only area, anomaly may occur in a mobile terminal that uses the memory, and further, a system cannot be started.

### SUMMARY

Embodiments of the present disclosure provide a data restoration method and apparatus, and a terminal such that the terminal may automatically restore a system when an error occurs in data in a read-only area of a memory.

According to a first aspect, a memory data restoration method is provided, where the method is used to restore data in a memory, the memory is included in a terminal, and the method includes monitoring whether an error occurs in original data stored in a read-only area of the memory when the terminal runs or loads a first operating system, loading a second operating system from the memory when an error occurs in the original data, where the second operating system provides at least a system restoration function, and obtaining an original data file corresponding to the original data, and restoring the original data to the read-only area of the memory according to the original data file when the terminal runs the second operating system.

In a first possible implementation manner of the first aspect, monitoring whether an error occurs in original data stored in a read-only area of the memory includes checking each block of data in the original data stored in the read-only area of the memory to obtain a first check value corresponding to each block of data in a one-to-one manner, where the read-only area includes at least one partition, and the at least one partition includes at least one block of data, and determining whether a first check value of a first block of data is the same as an original check value of the first block of data, where the first block of data is any block of data in the original data, and an error occurs in the original data if the first check value is different from the original check value.

With reference to the first possible implementation manner of the first aspect, in a second possible implementation manner, when the first check value is different from the original check value, the method further includes recording information about the first block of data.

With reference to any one of the first aspect or the foregoing possible implementation manners of the first aspect, in a third possible implementation manner, obtaining an original data file corresponding to the original data includes sending, by the terminal, an obtaining request to an external device, where the obtaining request is used for obtaining the original data file corresponding to the original data, and receiving, by the terminal, the original data file sent by the external device.

With reference to the third possible implementation manner of the first aspect, in a fourth possible implementation manner, the obtaining request includes a model of the terminal and a version of the first operating system, and the original data file is a mirror of the original data.

With reference to the third possible implementation manner of the first aspect, in a fifth possible implementation manner, the obtaining request includes a model of the terminal, a version of the first operating system, and block information of original data in which an error occurs, and the original data file is a mirror of the original data corresponding to the block information.

With reference to any one of the first aspect or the foregoing possible implementation manners of the first aspect, in a sixth possible implementation manner, the read-only area includes system files of at least two second operating systems, and loading a second operating system includes loading a normal second operating system in the at least two second operating systems.

According to a second aspect, a data restoration apparatus is provided, where the apparatus is configured to restore data in a memory, the memory is included in a terminal, and the apparatus includes a monitor unit configured to monitor whether an error occurs in original data stored in a read-only area of the memory when the terminal runs or loads a first operating system, a loading unit configured to load a second operating system from the memory when an error occurs in the original data, where the second operating system provides at least a system restoration function, and when the terminal runs the second operating system, a restoration unit configured to obtain an original data file corresponding to the original data, and restore the original data to the read-only area of the memory according to the original data file.

In a first possible implementation manner of the second aspect, the monitor unit includes a check unit and a determining unit. The check unit is configured to check each block of data in the original data stored in the read-only area of the memory to obtain a first check value corresponding to each block of data in a one-to-one manner when the terminal runs or loads the first operating system, where the read-only area includes at least one partition, and the at least one partition includes at least one block of data, and the determining unit is configured to determine whether a first check value of a first block of data is the same as an original check value of the first block of data, where the first block of data is any block of data in the original data, and an error occurs in the original data if the first check value is different from the original check value.

With reference to the first possible implementation manner of the second aspect, in a second possible implementation manner, the apparatus further includes a record unit configured to record information about the first block of data when the determining unit determines that the first check value is different from the original check value.

With reference to any one of the second aspect or the foregoing possible implementation manners of the second aspect, in a third possible implementation manner, obtaining an original data file corresponding to the original data includes sending an obtaining request to an external device, where the obtaining request is used for obtaining the original data file corresponding to the original data, and receiving the original data file sent by the external device.

With reference to the third possible implementation manner of the second aspect, in a fourth possible implementation manner, obtaining request includes a model of the terminal and a version of the first operating system, and the original data file is a mirror of the original data.

With reference to the third possible implementation manner of the second aspect, in a fifth possible implementation manner, obtaining request includes a model of the terminal, a version of the first operating system, and block information of original data in which an error occurs, and the original data file is a mirror of the original data corresponding to the block information.

With reference to any one of the second aspect or the foregoing possible implementation manners of the second aspect, in a sixth possible implementation manner, the read-only area includes system files of at least two second operating systems, and loading a second operating system includes loading a normal second operating system in the at least two second operating systems.

According to a third aspect, a terminal is provided and includes a processor, a memory, and a communications interface, where the memory is configured to store program code. The processor, the memory, and the communications interface communicate with each other using a bus, and the processor is configured to read data and the program code that are stored in the memory in order to execute the operations of monitoring whether an error occurs in original data stored in a read-only area of the memory when the terminal runs or loads a first operating system, loading a second operating system from the memory when an error occurs in the original data, where the second operating system provides at least a system restoration function, and obtaining an original data file corresponding to the original data, and restoring the original data to the read-only area of the memory according to the original data file when the terminal runs the second operating system.

In a first possible implementation manner of the third aspect, monitoring whether an error occurs in original data stored in a read-only area of the memory includes checking each block of data in the original data stored in the read-only area of the memory to obtain a first check value corresponding to each block of data in a one-to-one manner, where the read-only area includes at least one partition, and the at least one partition includes at least one block of data, and determining whether a first check value of a first block of data is the same as an original check value of the first block of data, where the first block of data is any block of data in the original data, and an error occurs in the original data if the first check value is different from the original check value.

With reference to the first possible implementation manner of the third aspect, in a second possible implementation manner, when determining that the first check value is different from the original check value, the processor further executes the operation of recording information about the first block of data.

With reference to any one of the third aspect or the foregoing possible implementation manners of the third aspect, in a third possible implementation manner, obtaining an original data file corresponding to the original data includes sending an obtaining request to an external device, where the obtaining request is used for obtaining the original data file corresponding to the original data, and receiving the original data file sent by the external device.

With reference to the third possible implementation manner of the third aspect, in a fourth possible implementation manner, the obtaining request includes a model of the terminal and a version of the first operating system, and the original data file is a mirror of the original data.

With reference to the third possible implementation manner of the third aspect, in a fifth possible implementation manner, the obtaining request includes a model of the terminal, a version of the first operating system, and block information of original data in which an error occurs, and the original data file is a mirror of the original data corresponding to the block information.

With reference to any one of the third aspect or the foregoing possible implementation manners of the third aspect, in a sixth possible implementation manner, the read-only area includes system files of at least two second operating systems, and when executing the operation of loading the second operating system, the processor further executes the operation of loading a normal second operating system in the at least two second operating systems.

In the embodiments of the present disclosure, original data stored in a read-only area of a memory is monitored. A second operating system is loaded from a terminal when an error occurs in the original data. An original data file stored in the read-only area is obtained when the second operating system is run, and the original data is restored to the read-only area of the memory according to the original data file. Therefore, the terminal may automatically restore a system when an error occurs in data in the read-only area of the memory. This reduces terminal maintenance costs.

### BRIEF DESCRIPTION OF DRAWINGS

FIG. 1 is a flowchart of a data restoration method according to an embodiment of the present disclosure;

FIG. 2 is a flowchart of another data restoration method according to an embodiment of the present disclosure;

FIG. 3 is a schematic diagram of a data restoration apparatus according to an embodiment of the present disclosure;

FIG. 4 is a schematic diagram of another data restoration apparatus according to an embodiment of the present disclosure; and

FIG. 5 is a schematic diagram of a terminal according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

Ordinal numbers such as “first” and “second,” if mentioned in the embodiments of the present disclosure, are only used for distinguishing, unless the ordinal numbers definitely represent a sequence according to the context.

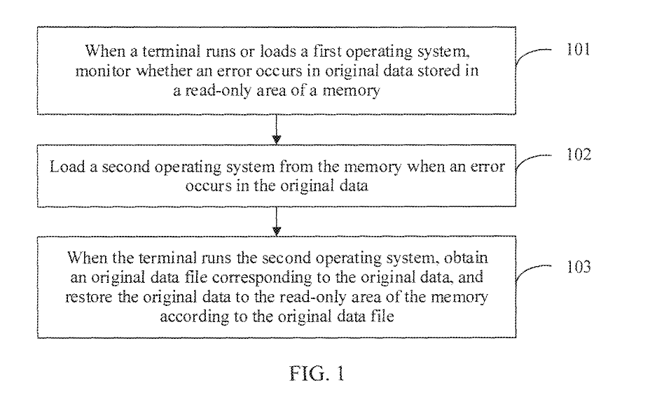

FIG. 1 is a flowchart of a data restoration method according to an embodiment of the present disclosure. As shown in FIG. 1, the method includes the following steps.

Step 101: When a terminal runs or loads a first operating system, monitor whether an error occurs in original data stored in a read-only area of a memory.

A terminal memory generally includes a readable area and a read-only area according to a read attribute of data. Data in the readable area can be read and written. Data in the read-only area is read-only in a normal situation, that is, cannot be overwritten, and this area is generally a program area and an area in which data cannot be changed. If an error or an anomaly occurs in data in the read-only area, the terminal probably cannot normally load an operating system, or a running operating system crashes and cannot be started.

In this embodiment of the present disclosure, the original data stored in the read-only area of the memory may be monitored when the terminal runs the first operating system, or the original data stored in the read-only area of the memory may be monitored when the terminal loads the first operating system before delivery or during initialization or switching on the terminal. For example, the original data stored in the read-only area of the memory may be monitored by starting a background process in order to find in a timely manner an error or an anomaly in data stored in the read-only area.

Loading an operating system refers to a process of enabling an operating system. When loading is completed, the operating system is normally started, and the terminal runs the loaded operating system.

The first operating system is a general-purpose operating system. In this embodiment of the present disclosure, the first operating system may be, such as, an ANDROID operating system of the GOOGLE Incorporated, an IOS operating system developed by the APPLE Incorporated, a WINDOWS operating system developed by the MICROSOFT Corporation, a SYMBIAN operating system, or a BLACKBERRY operating system.

Step 102: Load a second operating system from the memory when an error occurs in the original data, where the second operating system provides a system restoration function.

In the first operating system, a user can normally use the terminal. In step 101 in this embodiment of the present disclosure, when running or loading the first operating system, the terminal monitors the original data stored in the read-only area of the memory. When an error occurs in the original data stored in the read-only area, that is, the first operating system may not normally run or may crash, the second operating system is loaded from the terminal.

It should be noted that the second operating system may be an operating system the same as the first operating system, may be any one of the foregoing general-purpose operating systems except the first operating system, or may be a minimum system different from the first operating system.

The minimum system is a system that can provide a user with a restoration screen while occupying as less read-only area space as possible. The minimum system has at least a function of normally starting or restarting a central processing unit (CPU), a function of reading a random access memory (RAM), or an external connection function.

It should be noted that the minimum system has the function of normally starting or restarting a CPU to ensure that the terminal can enable the minimum system when monitoring that an error occurs in the original data in read-only area of the memory. The minimum system has the function of reading a RAM, to ensure that data can be read from the memory when the minimum system is run. The minimum system has the external connection function to ensure a connection between the terminal and an external device to obtain required data.

Optionally, the minimum system further includes a function of backing up data. Based on the function, the terminal may back up data or give up backing up data in the minimum system. For example, backup data may be backed up to an external memory, such as a secure digital (SD) card.

No matter whether the second operating system is a general-purpose operating system or a minimum system, when an error occurs in the original data, the terminal can be rebooted and load the second operating system from the memory such that the terminal runs the second operating system and provides a restoration function at a restoration screen.

The restoration screen includes at least connection and restoration options. Optionally, when the minimum system includes the function of backing up data, the restoration screen further has an option of backing up data.

Further, in this embodiment of the present disclosure, system files of at least two second operating systems may be included in the read-only area, and loading a second operating system includes loading a normal second operating system in the at least two second operating systems. Namely, data of the second operating system is backed up in two partitions. This may avoid a case in which the terminal cannot enable the second operating system because an error occurs in data of the second operating system.

It should be noted that the system file of the second operating systems is also located in the read-only area of the memory. In this embodiment of the present disclosure, whether an error occurs in data of the second operating system may be monitored. For a monitoring method, refer to the monitoring method in step 101. When an error is found in data of the second operating system, the terminal may mark the system such that when loading the second operating system, the terminal may choose to load a second operating system in which no error occurs.

Step 103: When the terminal runs the second operating system, obtain an original data file corresponding to the original data, and restore the original data to the read-only area of the memory according to the original data file.

When loading the second operating system is complete, the terminal runs the second operating system. The terminal may obtain a mirror of the original data stored in the read-only area, and write the obtained mirror of the original data into the read-only area of the memory by covering erroneous data in the read-only area, or delete erroneous data from the read-only area, and then write the obtained mirror of the original data into the read-only area of the memory in order to restore data in the read-only area to the memory.

In this embodiment of the present disclosure, original data stored in a read-only area of a memory is monitored. A second operating system is loaded from a terminal when an error occurs in the original data. An original data file stored in the read-only area is obtained when the second operating system is run, and the original data is restored to the read-only area of the memory according to the original data file. Therefore, the terminal may automatically restore a system when an error occurs in data in the read-only area of the memory. This reduces terminal maintenance costs and improves maintenance efficiency.

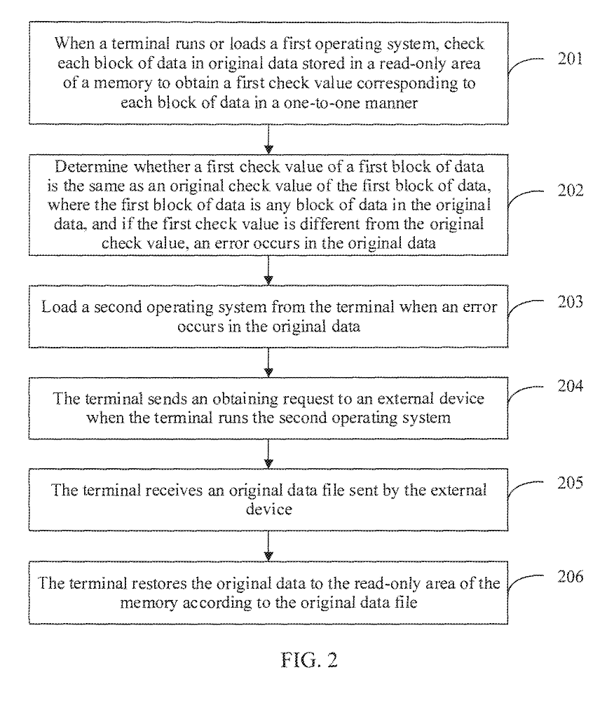

FIG. 2 is a flowchart of another data restoration method according to an embodiment of the present disclosure. On the basis of the embodiment shown in FIG. 1, as shown in FIG. 2, the method includes the following steps.

Step 201: When the terminal runs or loads the first operating system, check each block of data in the original data stored in the read-only area of the memory to obtain a first check value corresponding to each block of data in a one-to-one manner, where the read-only area includes at least one partition, and the at least one partition includes at least one block of data.

The read-only area of the terminal memory may be divided into one or more partitions, each partition includes one or more blocks, and a block of data may be stored in the block. The terminal may check each block of data in the read-only area of the memory during starting or initializing the terminal or after starting or initializing the terminal to obtain and save an original check value of each block of data.

Afterward, when the terminal runs or loads the first operating system, each block of data in the original data in the read-only area may be successively checked at a fixed time interval in a manner such as starting a process to obtain the first check value corresponding to each block of data such that the original data stored in the read-only area is monitored.

When obtaining the first check value of each block of data, blocks of data in all partitions may be sequentially checked, that is, all blocks of data are successively checked, blocks of data in all partitions may be checked at the same time, that is, all of the partitions are checked at the same time, and all blocks in a same partition are successively checked, or check may be performed in any combination of the foregoing two manners.

Further, in this embodiment of the present disclosure, the original data is continuously and cyclically checked before a data error is found in the read-only area.

Further, a data check manner used in this embodiment of the present disclosure may be, such as, a cyclic redundancy check (CRC), a message digest algorithm 5 (MD5) check, or a secure hash algorithm (SHA1) check.

Step 202: Determine whether a first check value of a first block of data is the same as an original check value of the first block of data, where the first block of data is any block of data in the original data, and if the first check value is different from the original check value, an error occurs in the original data.

In a process of checking each block of data in the read-only area, whether the first check value of the first block of data is the same as the original check value of this block of data is compared in order to determine whether an error occurs in the first block of data.

If the original check value of the first block of data is the same as the first check value, it indicates that no change occurs in the data, that is, no error occurs. When an error is not found, each block of data is continuously checked according to the foregoing step.

When the first check value of the first block of data is different from the original check value, it is considered that a change occurs in the data in the read-only area, that is, an error occurs in the original data stored in the read-only area.

Further, in this embodiment of the present disclosure, information about the first block of data may be recorded when the first check value of the first block of data is different from the original check value. The information about the first block of data is block information, and the block information may be location information of the first block, or the like.

Step 203: Load a second operating system from the terminal when an error occurs in the original data, where the second operating system provides at least a system restoration function.

Step 203 is the same as step 102 in the embodiment shown in FIG. 1, and details are not described herein again.

Step 204: The terminal sends an obtaining request to an external device when the terminal runs the second operating system, where the obtaining request is used for obtaining the original data file corresponding to the original data.

The obtaining request may be a request for obtaining all the original data in the read-only area, or may be a request for obtaining some original data that is in the read-only area and in which an error occurs.

For example, when the obtaining request includes a model of the terminal and a version of the first operating system, data requested for obtaining is a mirror of all the original data stored in the read-only area corresponding to the model of the terminal and the version.

When the obtaining request includes a model of the terminal, a version of the first operating system, and block information of original data in which an error occurs, data requested for obtaining is a mirror of the erroneous block of original data stored in the read-only area corresponding to the model of the terminal, the version of the first operating system, and the block information of the original data in which the error occurs. For example, when an error occurs in the first block of data, block information of the first block of data in which the error occurs is recorded, that is, location information of a block in which the first block of data locates.

Step 205: The terminal receives the original data file sent by the external device. In this embodiment of the present disclosure, a method for obtaining, by the terminal from the external device, a mirror of the original data stored in the read-only area may be downloading a stored mirror of the original data from a server using WI-FI, downloading a stored mirror of the original data from a terminal, such as a personal computer (PC), using a data cable, or the like.

Step 206: The terminal restores the original data to the read-only area of the memory according to the original data file.

In this embodiment of the present disclosure, each block of data in a read-only area of a memory is checked in order to find a data error in the read-only area in a timely manner, and a restoration system is automatically run to restore original data when a data error is found such that a terminal can automatically restore a system when an error occurs in data in the read-only area of the memory. This reduces terminal maintenance costs and improves maintenance efficiency.

The embodiments of the present disclosure further provide a memory data restoration apparatus implementing the steps and the methods in the foregoing method embodiments.

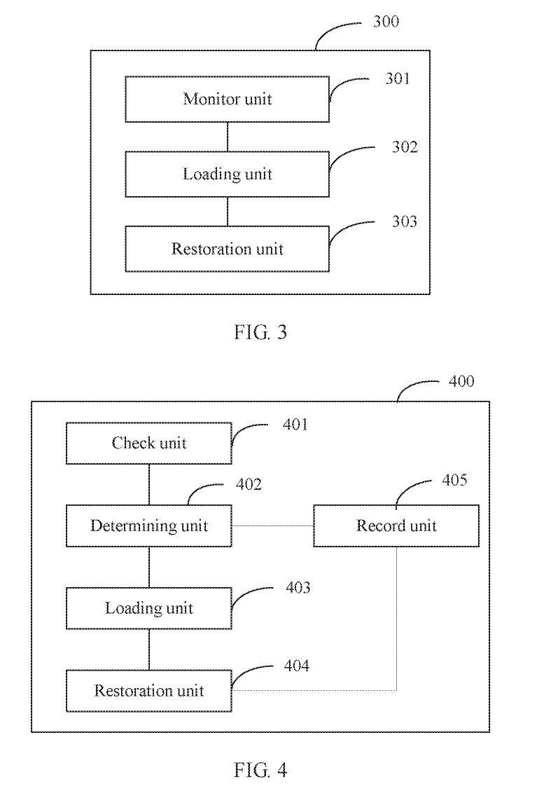

FIG. 3 is a schematic diagram of a data restoration apparatus 300 according to an embodiment of the present disclosure. As shown in FIG. 3, the data restoration apparatus 300 includes a monitor unit 301, a loading unit 302, and a restoration unit 303.

The monitor unit 301 is configured to monitor whether an error occurs in original data stored in the read-only area of a memory when a terminal runs or loads a first operating system.

The loading unit 302 is configured to load a second operating system from the memory when an error occurs in the original data, where the second operating system provides a system restoration function.

It should be noted that optionally, the read-only area in this embodiment of the present disclosure includes system files of at least two second operating systems, and a normal second operating system in the at least two second operating systems is loaded.

The restoration unit 303 is configured to obtain an original data file corresponding to the original data, and restore the original data to the read-only area of the memory according to the original data file when the terminal runs the second operating system.

In this embodiment of the present disclosure, original data stored in a read-only area of a memory is monitored. A second operating system is loaded from a terminal when an error occurs in the original data. An original data file stored in the read-only area is obtained when the second operating system is run, and the original data is restored to the read-only area of the memory according to the original data file. Therefore, the terminal may automatically restore a system when an error occurs in data in the read-only area of the memory. This reduces terminal maintenance costs and improves maintenance efficiency.

The data restoration apparatus 300 provided in this embodiment of the present disclosure is configured to implement the methods in the embodiments shown in FIG. 1 and FIG. 2. For a specific operating principle and work process of the data restoration apparatus 300 and a technical effect produced by the data restoration apparatus 300, refer to the embodiments shown in FIG. 1 and FIG. 2. Details are not described herein again.

FIG. 4 is a schematic diagram of another data restoration apparatus 400 according to an embodiment of the present disclosure. On the basis of the embodiment shown in FIG. 3, as shown in FIG. 4, the data restoration apparatus 400 includes a check unit 401, a determining unit 402, a loading unit 403, a restoration unit 404, and a record unit 405.

The check unit 401 is configured to check each block of data in the original data stored in the read-only area of the memory to obtain a first check value corresponding to each block of data in a one-to-one manner when the terminal runs or loads the first operating system, where the read-only area includes at least one partition, and the at least one partition includes at least one block of data.

The determining unit 402 is configured to determine whether a first check value of a first block of data is the same as an original check value of the first block of data, where the first block of data is any block of data in the original data, and an error occurs in the original data if the first check value is different from the original check value.

The loading unit 403 is configured to load a second operating system from the memory when an error occurs in the original data, where the second operating system provides at least a system restoration function.

The restoration unit 404 is configured to send an obtaining request to an external device when the terminal runs the second operating system, where the obtaining request is used for obtaining the original data file corresponding to the original data, and receive the original data file sent by the external device.

It should be noted that when the obtaining request includes a model of the terminal and a version of the first operating system, the original data file is a mirror of the original data.

Optionally, this embodiment of the present disclosure may further include the record unit 405 configured to record information about the first block of data when the determining unit 402 determines that the first check value is different from the original check value.

When the obtaining request includes a model of the terminal, a version of the first operating system, and block information of original data in which an error occurs, the original data file is a mirror of the original data corresponding to the block information.

In this embodiment of the present disclosure, data in a read-only area of a memory is monitored in order to find an error of read-only data in a timely manner, and when a data error is found, a restoration system is automatically run to restore original data such that a terminal can automatically restore a system when an error occurs in data in the read-only area of the memory. This reduces terminal maintenance costs, and improves maintenance efficiency.

The data restoration apparatus 400 provided in this embodiment of the present disclosure is configured to implement the methods in the embodiments shown in FIG. 1 and FIG. 2. For a specific operating principle and work process of the data restoration apparatus 400 and a technical effect produced by the data restoration apparatus, refer to the embodiments shown in FIG. 1 and FIG. 2. Details are not described herein again.

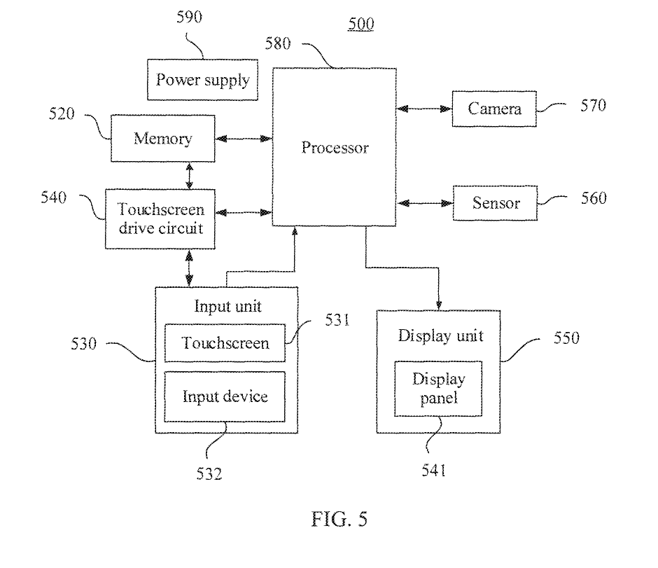

FIG. 5 is a schematic diagram of a terminal according to an embodiment of the present disclosure.

The terminal may be a mobile phone, a tablet computer, a notebook computer, a ultra-mobile PC (UMPC), a netbook, a personal digital assistant (PDA), or the like. In this embodiment of the present disclosure, a mobile phone is used as an example for describing the terminal. FIG. 5 shows a block diagram of a partial structure of a mobile phone 500 related to this embodiment of the present disclosure.

As shown in FIG. 5, the mobile phone 500 includes components such as a memory 520, an input unit 530, a touchscreen drive circuit 540, a display unit 550, a sensor 560, a camera 570, a processor 580, and a power supply 590. A person skilled in the art may understand that the structure of the mobile phone 500 shown in FIG. 5 imposes no limitation on the mobile phone 500, and instead, the mobile phone 500 may include components more or fewer than those shown in FIG. 5, a combination of some components, or different component arrangements.

The following describes each component of the mobile phone 500 in detail with reference to FIG. 5.

The memory 520 may be configured to store a software program and a module, and the processor 580 runs the software program and the module that are stored in the memory 520 in order to execute various functional applications of the mobile phone 500 and perform data processing. The memory 520 may primarily include a program storage area and a data storage area. The program storage area may store an operating system, an application program required by at least one function (such as an audio play function or a video play function), and the like. The data storage area may store data (such as audio data, video data, or a phonebook) created according to use of the mobile phone 500, and the like. In addition, the memory 520 may include a high-speed RAM, and may further include a nonvolatile memory, such as at least one magnetic disk storage, a flash memory, or another non-volatile solid-state storage.

The input unit 530 may be configured to receive entered digit or character information, and generate key signal input related to user setting and function control of the mobile phone 500. Further, the input unit 530 may include a touchscreen 531 and an input device 532. The touchscreen 531 is also referred to as a touch panel and may collect a touch operation (such as an operation performed by a user on the touchscreen 531 or near the touchscreen 531 using any proper object or accessory, such as a finger or a stylus) performed by a user on or near the touchscreen 531, and drive a corresponding connection apparatus according to a preset program. Optionally, the touchscreen 531 may include two parts, a touch detection apparatus and a touch controller (not shown). The touch detection apparatus detects a touch position of the user, detects a signal brought by a touch operation, and transfers the signal to the touch controller. The touch controller receives touch information from the touch detection apparatus, converts the touch information into coordinates of a touch point, then sends the coordinates of the touch point to the processor 580, and can receive and execute a command sent by the processor 580. In addition, the touchscreen 531 may be implemented using multiple types such as a resistive type, a capacitive type, infrared, and a surface acoustic wave. The input device 532 may include but is not limited to one or more of a physical keyboard, a function key (such as a volume control key or a power switch key not shown), a trackball, a mouse, a joystick, or the like.

The touchscreen drive circuit 540 may be configured to obtain a location of a touch and control point triggered in the touchscreen 531 and a quantity of touch and control points. For example, in a capacitive touchscreen, the touchscreen drive circuit 540 may calculate a capacitance change in each touch and control point of the touchscreen 531 to obtain the location of the triggered touch and control point and the quantity of triggered touch and control points. Optionally, the touchscreen drive circuit 540 may be included in the touch detection apparatus or the touch controller.

The display unit 550 may be configured to display information entered by the user or information provided for the user, and various menus of the mobile phone 500. The display unit 550 may include a display panel 541, and optionally, and the display panel 541 may be configured in a form of a liquid crystal display (LCD), an organic light-emitting diode (OLED), or the like. Further, the touchscreen 531 may cover the display panel 541. When the touchscreen 531 detects a touch operation on or near the touchscreen 531, the touchscreen 531 transfers the touch operation to the processor 580 to determine a touch event type, and then the processor 580 provides corresponding visual output on the display panel 541 according to the touch event type. In FIG. 5, the touchscreen 531 and the display panel 541 are used as two separate components to implement an input and output function of the mobile phone 500. However, in some embodiments, the touchscreen 531 and the display panel 541 may be integrated to implement the input and output function of the mobile phone 500.

The mobile phone 500 may further include at least one type of sensor 560, such as a light sensor, a motion sensor, an intensity sensor, a fingerprint sensor, and another sensor. Further, the light sensor may include an ambient light sensor and a proximity sensor. The ambient light sensor may adjust luminance of the display panel 541 according to brightness of ambient light. The proximity sensor may detect whether an object is close to or touch the mobile phone, and may close the display panel 541 and/or backlight when the mobile phone 500 approaches an ear. As a type of motion sensor, an accelerometer sensor may detect a value of acceleration in each direction (generally, three axes), may detect a value and a direction of gravity in a static mode, and may be used for an application that identifies a phone gesture (such as screen orientation, related games, and magnetometer gesture calibration), a function related to vibration identification (such as a pedometer and a stroke), and the like. The intensity sensor may detect intensity of an object in contact with the mobile phone. The fingerprint sensor is configured to collect a fingerprint entered by the user. For the mobile phone 500, a gyroscope, a barometer, a hygrometer, a thermometer, an infrared sensor, and other sensors may be further configured, and details are not described herein.

The camera 570 is a built-in camera of the mobile phone, and may be a front-facing camera, or may be a rear-facing camera.

The processor 580 is a control center of the mobile phone 500, and uses various interfaces and lines to connect all parts of the entire mobile phone. By running or executing the software program and/or the module that are stored in the memory 520 and invoking data stored in the memory 520, the processor 580 executes various functions of the mobile phone 500 and processes data in order to monitor the entire mobile phone 500. Optionally, the processor 580 may include one or more processing units. Preferably, an application processor and a modem processor may be integrated into the processor 580. The application processor mainly processes an operating system, a user interface, an application program, or the like. The modem processor mainly processes radio communications. It may be understood that the foregoing modem processor may not be integrated into the processor 580.

The mobile phone 500 further includes the power supply 590 (such as a battery) that supplies power to each component. Preferably, the power supply 590 may be logically connected to the processor 580 using a power management system in order to implement functions such as charging/discharging management, and power consumption management using the power management system.

Although not shown, the mobile phone 500 may further include a radio frequency (RF) circuit, an audio frequency circuit, a WI-FI module, a BLUETOOTH module, and the like. Details are not described herein.

In this embodiment of the present disclosure, the processor 580 is configured to read the program code and the data that are stored in the memory 520 in order to execute the operations of monitoring whether an error occurs in original data stored in a read-only area of the memory 520 when the mobile phone 500 runs or loads a first operating system, loading a second operating system from the memory 520 when an error occurs in the original data, where the second operating system provides at least a system restoration function, and obtaining an original data file corresponding to the original data, and restoring the original data to the read-only area of the memory 520 according to the original data file when the mobile phone 500 runs the second operating system.

Optionally, the read-only area includes system files of at least two second operating systems, and when executing the operation of loading the second operating system, the processor 580 loads a normal second operating system in the at least two second operating systems.

Further, obtaining an original data file corresponding to the original data, and restoring the original data to the memory 520 according to the original data file includes sending, to an external device, an obtaining request used for obtaining the original data file corresponding to the original data, receiving the original data file sent by the external device, and restoring the original data to the read-only area of the memory 520 according to the original data file.

It should be noted that when the obtaining request includes a model of the mobile phone 500 and a version of the first operating system, the original data file is a mirror of the original data.

Optionally, when determining that a first check value is different from an original check value, the processor 580 further executes the operation of recording information about a first block of data.

It should be noted that, when the obtaining request includes a model of the mobile phone 500, a version of the first operating system, and block information of original data in which an error occurs, the original data file is a mirror of the original data corresponding to the block information.

Further, monitoring whether an error occurs in original data stored in a read-only area of the memory 520 includes checking each block of data in the original data stored in the read-only area of the memory 520 to obtain a first check value corresponding to each block of data in a one-to-one manner, where the read-only area includes at least one partition, and the at least one partition includes at least one block of data, and determining whether a first check value of a first block of data is the same as an original check value of the first block of data, where the first block of data is any block of data in the original data, and if the first check value is different from the original check value, an error occurs in the original data.

In this embodiment of the present disclosure, original data stored in a read-only area of the memory 520 is monitored. A second operating system is loaded from the mobile phone 500 when an error occurs in the original data. An original data file stored in the read-only area is obtained when the second operating system is run, and the original data is restored to the read-only area of the memory 520 according to the original data file. Therefore, the mobile phone 500 may automatically restore a system when an error occurs in data in the read-only area of the memory 520. This reduces mobile phone 500 (i.e, terminal) maintenance costs and improves maintenance efficiency.

The mobile phone 500 provided in this embodiment of the present disclosure is configured to implement the methods in the embodiments shown in FIG. 1 and FIG. 2. For a specific operating principle and work process of the mobile phone 500 and a technical effect produced by the mobile phone 500, refer to the embodiments shown in FIG. 1 and FIG. 2. Details are not described herein again.

With descriptions of the foregoing embodiments, a person skilled in the art may clearly understand that the present disclosure may be implemented by hardware, firmware or a combination thereof. When the present disclosure is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM, a read-only memory (ROM), an electrically erasable programmable ROM (EEPROM), a compact disc ROM (CD-ROM), or another optical disc storage or a disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in a definition of a medium to which they belong. For example, a disk and disc used by the present disclosure includes a compact disc (CD), a laser disc, an optical disc, a digital versatile disc (DVD), a FLOPPY DISK and a BLU-RAY DISC, where the disk generally copies data by a magnetic means, and the disc copies data optically by a laser means. The foregoing combination should also be included in the protection scope of the computer-readable medium.

In conclusion, what is described above is merely example embodiments of the technical solutions of the present disclosure, but is not intended to limit the protection scope of the present disclosure. Any modification, equivalent replacement, or improvement made without departing from the spirit and principle of the present disclosure shall fall within the protection scope of the present disclosure.

1. A data restoration method, wherein the method is used to restore data in a memory comprised in a terminal, and wherein the method comprises:
monitoring whether an error occurs in original data stored in a read-only area of the memory when the terminal runs first operating system;
loading a second operating system from the memory when the error occurs in the original data, wherein the second operating system provides at least a system restoration function:
obtaining an original data file corresponding to the original data when the terminal runs the second operating system; and
restoring the original data to the read-only area of the memory according to the original data file.

2. The method according to claim 1, wherein monitoring whether the error occurs in the original data stored in the read-only area of the memory comprises:
checking each block of data in the original data stored in the read-only area of the memory to obtain a first check value corresponding to each block of data in a one-to-one manner, wherein the read-only area of the memory comprises at least one partition, and wherein the at least one partition comprises at least one block of data; and
when a first check value of a first block of data is different from an original check value of the first block of data, the error occurs in the original data, wherein the first block of data is any block of data in the original data.

3. The method according to claim 2, wherein when the first check value of the first block of data is different from the original check value of the first block of data, the method further comprises recording information about the first block of data.

4. The method according to claim 1, wherein obtaining the original data file comprises:
sending, by the terminal, an obtaining request to an external device, wherein the obtaining request is used for obtaining the original data file corresponding to the original data; and
receiving, by the terminal, the original data file from the external device.

5. The method according to claim 4, wherein the obtaining request comprises a model of the terminal and a version of the first operating system and wherein the original data file is a mirror of the original data.

6. The method according to claim 4, wherein the obtaining request comprises a model of the terminal, a version of the first operating system, and block information of the original data in which the error occurs, and wherein the original data file is a mirror of the original data corresponding to the block information.

7. The method according to claim 1, wherein the read-only area of the memory comprises system files of at least two second operating systems, and wherein loading the second operating system comprises loading a normal second operating system in the at least two second operating systems.

8.-14. (canceled)

15. A terminal, comprising:
a memory configured to store a program code;
a communications interface; and
a processor,
wherein the processor, the memory, and the communications interface communicate with each other using a bus, and
wherein the program code causes the processor to be configured to:
monitor whether an error occurs in original data stored in a read-only area of the memory when the terminal runs a first operating system;
load a second operating system from the memory when the error occurs in the original data, wherein the second operating system provides at least a system restoration function;
obtain an original data file corresponding to the original data when the terminal runs the second operating system; and
restore the original data to the read-only area of the memory according to the original data file.

16. The terminal according to claim 15, wherein when whether the error occurs in the original data stored in the read-only area of the memory, the program code further causes the processer to be configured to:
check each block of data in the original data stored in the read-only area of the memory to obtain a first check value corresponding to each block of data in a one-to-one manner, wherein the read-only area of the memory comprises at least one partition, and wherein the at least one partition comprises at least one block of data; and
when a first check value of a first block of data is different from an original check value of the first block of data, the error occurs in the original data, wherein the first block of data is any block of data in the original data.

17. The terminal according to claim 16, wherein when determining that the first check value of the first block of data is different from the original check value of the first block of data, the program code further causes the processor to be configured to record information about the first block of data.

18. The terminal according to claim 15, wherein when obtaining the original data file, the program code further causes the processor to be configured to:
send an obtaining request to an external device, wherein the obtaining request is used for obtaining the original data file corresponding to the original data; and
receive the original data file from the external device.

19. The terminal according to claim 18, wherein the obtaining request comprises a model of the terminal and a version of the first operating system, and wherein the original data file is a mirror of the original data.

20. The terminal according to claim 18, wherein the obtaining request comprises a model of the terminal, a version of the first operating system, and block information of the original data in which the error occurs, and wherein the original data file is a mirror of the original data corresponding to the block information.

21. The terminal according to claim 15, wherein the read-only area of the memory comprises system files of at least two second operating systems, and wherein when loading the second operating system, the program code further causes the processor to be configured to load a normal second operating system in the at least two second operating systems.

22. A non-transitory computer readable storage medium comprising instructions which, when executed by a computer, cause the computer to carry out a method comprising
monitoring whether an error occurs in original data stored in a read-only area of a memory when the computer runs or loads a first operating system;
loading a second operating system from the memory when the error occurs in the original data, wherein the second operating system provides at least a system restoration function;
obtaining an original data file corresponding to the original data when the computer runs the second operating system; and
restoring the original data to the read-only area of the memory according o the original data file.

23. A data restoration method, wherein the method is used to restore data in a memory comprised in a terminal, and wherein the method comprises:
monitoring whether an error occurs in original data stored in a read-only area of the memory when the terminal loads a first operating system;
loading a second operating system from the memory when the error occurs in the original data, wherein the second operating system provides at least a system restoration function;
obtaining an original data file corresponding to the original data when the terminal runs the second operating system; and
restoring the original data to the read-only area of the memory according to the original data file.

24. The method according to claim 23, wherein monitoring whether the error occurs in the original data stored in the read-only area of the memory comprises:
checking each block of data in the original data stored in the read-only area of the memory to obtain a first check value corresponding to each block of data in a one-to-one manner, wherein the read-only area of the memory comprises at least one partition, and wherein the at least one partition comprises at least one block of data; and
when a first check value of a first block of data is different from an original check value of the first block of data, the error occurs in the original data, wherein the first block of data is any block of data in the original data.

25. The method according to claim 23, wherein obtaining the original data file comprises:
sending, by the terminal, an obtaining request to an external device, wherein the obtaining request is used for obtaining the original data file corresponding to the original data; and
receiving, by the terminal, the original data file from the external device.

26. The method according to claim 23, wherein the read-only area of the mentor comprises system files of at least two second operating systems, and wherein loading the second operating system comprises loading a normal second operating system in the at least two second operating systems.

27. A terminal, comprising:
a memory configured to store a program code;
a communications interface; and
a processor,
wherein the processor, the memory, and the communications interface communicate with each other using a bus, and
wherein the program code causes the processor to be configured to:
monitor whether an error occurs in original data stored in a read-only area of the memory when the terminal loads a first operating system;
load a second operating system from the memory when the error occurs in the original data, wherein the second operating system provides at least a system restoration function;
obtain an original data file corresponding to the original data when the terminal runs the second operating system; and
restore the original data to the read-only area of the memory according to the original data file.
